(19) United States
(12) Patent Application Publication
(10) Pub. No.: US 2011/0209122 A1
(43) Pub. Date: Aug. 25, 2011

(54) FILTERED PRESENTATION OF STRUCTURED DATA AT DEBUG TIME

(75) Inventors: Robert M. Fuhrer, Hawthorne, NY (US); Danny Soroker, Hawthorne, NY (US)

(73) Assignee: INTERNATIONAL BUSINESS MACHINES CORPORATION, Armonk, NY (US)

(21) Appl. No.: 12/709,877

(22) Filed: Feb. 22, 2010

(51) Int. Cl. G06F 11/36; G06F 3/048

(52) U.S. Cl. 717/125; 717/129

(57) ABSTRACT

A debugger provides a user interface for specifying filters of data structure data values. A programmer or the like specifies desired filters using the user interface. The debugger applies these filters to determine how to present program data, for example, at a breakpoint, or during a post-mortem inspection of program data.

### CROSS-REFERENCE TO RELATED APPLICATIONS

This application is related to U.S. patent application Ser. No. ______ (Attorney docket YOR920090615US1(24822)), entitled SELECTIVE AUTOMATED EXPANSION OF STRUCTURED DATA AT DEBUG TIME, filed on Feb. 22, 2010, which is incorporated by reference herein in its entirety.

### FIELD

The present application generally relates to computer systems, programming and error identification, and more particularly to filtered presentation of structured data at debug time.

### BACKGROUND

The amount of data accessible to an application program at any given execution instant is often very large, so that application developers are presented at debug time with large amounts of data, much of which may be irrelevant to the task at hand. This makes it difficult to focus on the salient aspects of the program's execution and its data state. Moreover, many common data structures contain vast amounts of bookkeeping data that may not be of interest. As a result, gaining a coherent picture of a data structure's contents at debug time can present a tedious task.

### BRIEF SUMMARY

A method and system for filtered presentation of structured data at debug time are provided. The method, in one aspect, may include enabling, using a processor, specifying of one or more filters for presentation during a debug procedure. The method may also include applying the one or more filters to data structures of a program execution environment. The method may further include presenting one or more data values of the data structures meeting one or more criteria specified in the one or more filters.

A system for filtered presentation of structured data at debug time, in one aspect, may include a user interface module operable to enable a user to specify one or more filters for presentation during debug procedure. A debug module may be operable to apply the one or more filters to data structures of a program execution environment and identify data values of the data structures meeting one or more criteria specified in the one or more filters.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 illustrates a structure of a type and type file as an example.

FIG. 2 is an architectural diagram illustrating functional components for a system that performs filtered presentation of structured data at debug time in one embodiment of the present disclosure.

FIG. 3 is a flow diagram illustrating the logic flow in one embodiment for filtered presentation of structured data at debug time.

FIG. 4 illustrates an example of a computer system, in which the systems and methodologies of the present disclosure may be carried out or executed.

### DETAILED DESCRIPTION

The present disclosure discloses a means, for instance, a method and/or system for the programmer to control at debug time the amount of data presented by the debugger for any given type of structured data.

In one aspect of the present disclosure, a set of filters are provided. The filters may be global, i.e. applicable to multiple programs that, e.g., share a common set of data types. Alternatively, the filters may be associated with a particular application being debugged. The debugger herein refers to an application, a module or a tool or the like that can be used for identifying errors in a program. The debugger may be a part of a programming environment, for instance, an integrated programming environment tool. The filters of the present disclosure may augment existing debuggers, and may be used as follows:
1. The debugger provides a user interface for specifying such filters.
2. The programmer specifies any desired filters through this user interface.
3. The debugger applies these filters to determine how to present program data, for example, at a breakpoint, or during a post-mortem inspection of program data.

In one aspect, there may be at most one filter for each data type in the application being debugged. This type filter identifies the set of fields to be displayed by the debugger whenever a value of that data type is to be displayed.

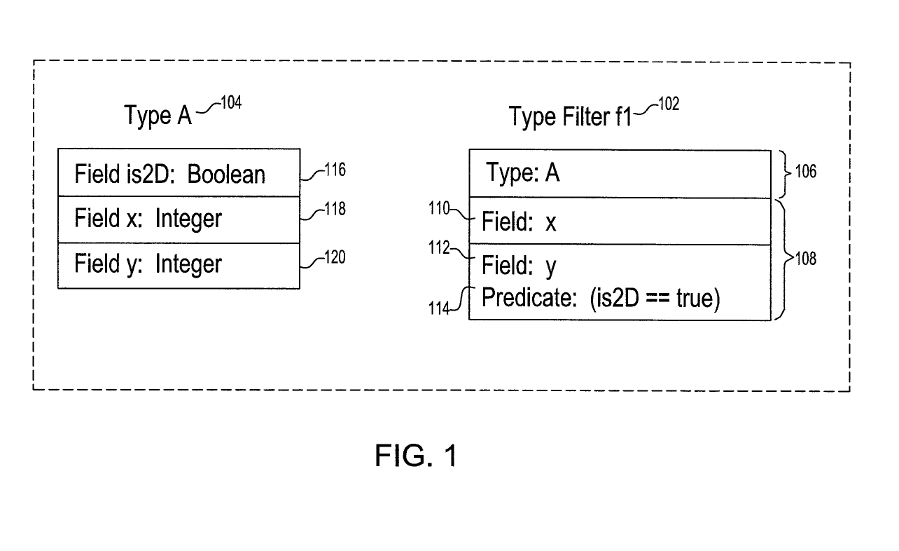

FIG. 1 illustrates a structure of a type and type filter as an example. A type filter 102 may include two parts: (1) a unique identification of the type to be filtered 106, and (2) a list of field filters 108. Each field filter may include a field name 110, 112, which uniquely identifies a field within the given type, and, optionally, (2) a predicate (e.g., a Boolean expression) 114. The type filter 102 shown in FIG. 1 specifies the unique identification of the type to be filtered as “A”, corresponding to the type “A” data structure 104. As shown, type “A” data structure 104 may include three fields: a Boolean field 116 named “is 2D”, an integer field 118 named “x”, and another integer field 120 named “y.”

In the case that no predicate is present in a given field filter, the corresponding field is always displayed whenever an instance of the given type of data is displayed. Conversely, any field for which there is no field filter in a given type filter would not be displayed by the debugger.

If, on the other hand, a given field specification contains a predicate, if that predicate evaluates to true, the field would be displayed. This means that at different points in a program's execution, a given instance of a given data type may be displayed with a different subset of its fields being visible.

In one aspect, a predicate expression may only reference data accessible from an object instance of the type associated with the filter. Specifically, though, predicate expressions may reference other fields in the given data type. For example, as shown in FIG. 1, a structured type “A” contains integer fields “x” and “y” and Boolean field “is 2D”; the type filter f1 instructs that the field “is 2D” is always hidden (because that field does not appear in the filter), the field “x” is always shown (indicated by filter 110), and the field “y” is shown only when “is 2D” is true (as indicated by filter 112 and 114). A predicate expression may also reference globally-accessible data, as well as any other data that is accessible indirectly via the fields of the given filter's associated data type.

While the above example illustrated the filter specification as specifying those fields which are to be displayed, filter specifications can also be used in a converse manner. That is, the filter mechanism of the present disclosure may be implemented so that those fields specified in the type field are not displayed, instead of being displayed.

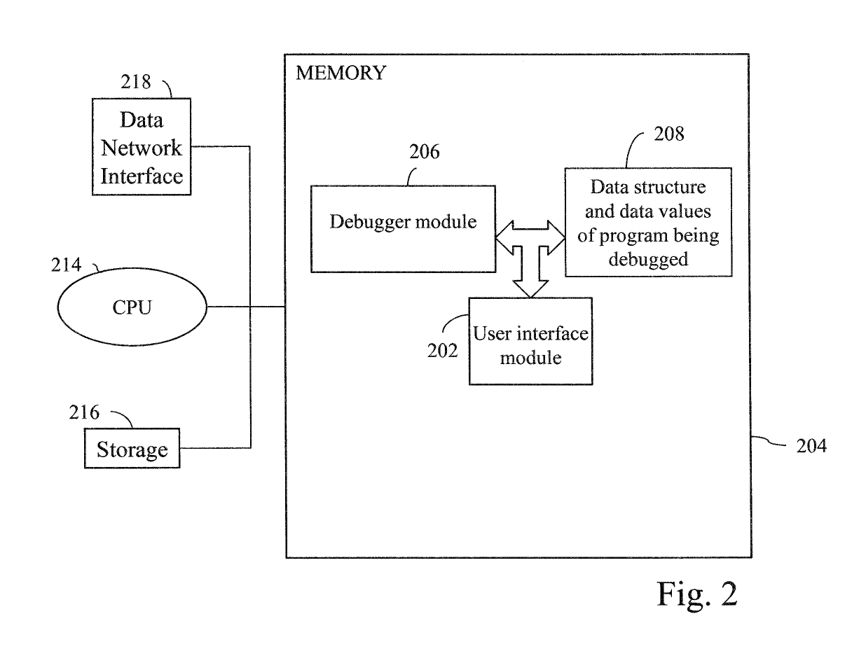

FIG. 2 is an architectural diagram illustrating functional components for a system that performs filtered presentation of structured data at debug time in one embodiment of the present disclosure. The modules shown in FIG. 2 may be components of a computer system that may include any computing node that is able to load and execute programmatic code, for instance, running the operating system and server or the like application suite. The system logic may be embodied as computer executable code that is loaded from a remote source (e.g., from a network file system), local permanent optical (CD-ROM), magnetic storage (such as disk), or storage 216 into memory 204 for execution by CPU 214. A network interface 218 may be used for communicating to other network accessible services. Such an interface 218 may include, but is not limited to a hardwired device, e.g., Ethernet over coax cable, wireless IP, and telephone to IP (VoIP), or others. The memory 204 may include computer readable instructions, data structures, program modules and application interfaces providing logic or functional components for filtered presentation of structured data at debug time.

A user interface module 202 presents to the user an interface, for instance, a display screen form for allowing the user to enter the desired filters, i.e., the types of data structure by unique identification and the fields of that data structure the user desires to see during the debug procedure or process, and any conditions under which the user desires to see the values for those fields. The input form may have enterable input fields, a list of menu items to select from or others. Other input mechanisms other than a display form may be utilized, for example, voice activated input and/or others. As explained above, the conditions may be specified by a predicate specification in the filter. During debug time, a debug module 206 applies the filters specified by the user to the data structure and data values of the program being debugged 208. At the predetermined or specified points of execution in the program, the data structure, data field values, and those data field values in which a condition was specified and those that satisfy the condition are presented to the user, for example, via the user interface module 202. The debugger module 206 and the user interface module 202 may be implemented as part of an integrated software development environment, which for example, enable users to program, execute, test and debug programs.

It should be understood that while FIG. 2 illustrates the functional components residing in a computer system, the system and method of the present disclosure is not limited to only that configuration. Thus, the components may be distributed over a network on different platforms in a distributed environment, and/or configured in a cloud computing environment. Further, while FIG. 2 shows a CPU 214, the system may include multiple processors and/or cores.

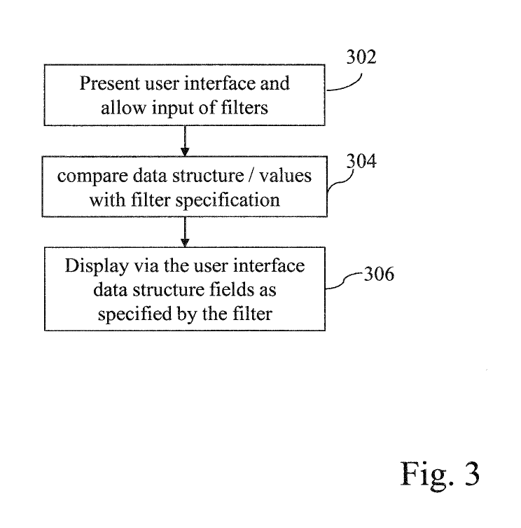

FIG. 3 is a flow diagram illustrating the logic flow in one embodiment for filtered presentation of structured data at debug time. At 302, a user may enter filters, for example, via a user interface program. At 304, the debugger applies the filter to the program execution environment, e.g., the data structures in the program and the data values those data structures take on as the program executes. The debugger may apply the filter at specified points in the program execution, for example, during the specified breakpoints, and or other specified points in the program execution. The data values of the data structured fields specified via the filter are presented to the user at 306, for instance, via a user interface. In another aspect, the data values may be presented from inspecting the data dump of the program execution, e.g., after the program finishes executing. The data values may be sampled periodically and presented dynamically during the program execution.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

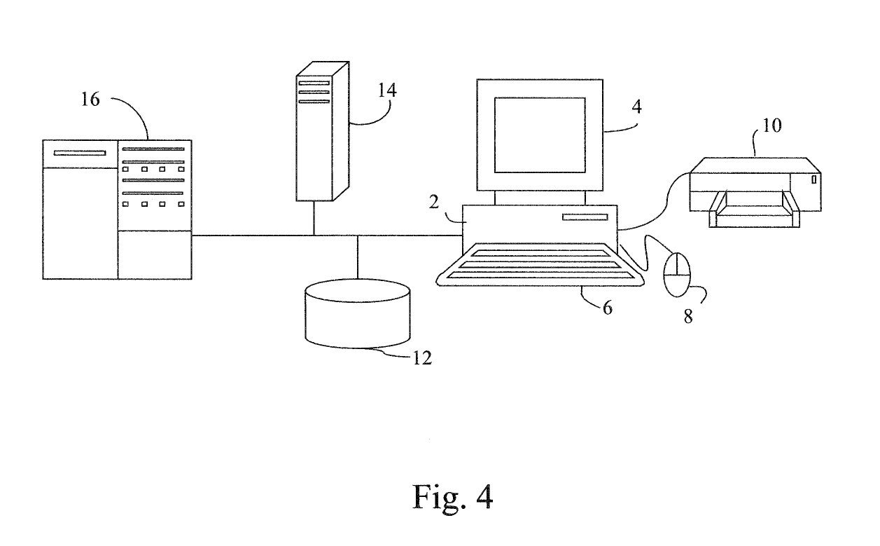

Referring now to FIG. 4, the systems and methodologies of the present disclosure may be carried out or executed in a computer system that includes a processing unit 2, which houses one or more processors and/or cores, memory and other systems components (not shown expressly in the drawing) that implement a computer processing system, or computer that may execute a computer program product. The computer program product may comprise media, for example a hard disk, a compact storage medium such as a compact disc, or other storage devices, which may be read by the processing unit 2 by any techniques known or will be known to the skilled artisan for providing the computer program product to the processing system for execution.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following; (a) conversion to another language, code or notation; and/or (b) reproduction in a different material form.

The computer processing system that carries out the system and method of the present disclosure may also include a display device such as a monitor or display screen 4 for presenting output displays and providing a display through which the user may input data and interact with the processing system, for instance, in cooperation with input devices such as the keyboard 6 and mouse device 8 or pointing device. The computer processing system may be also connected or coupled to one or more peripheral devices such as the printer 10, scanner (not shown), speaker, and any other devices, directly or via remote connections. The computer processing system may be connected or coupled to one or more other processing systems such as a server 10, other remote computer processing system 14, network storage devices 12, via any one or more of a local Ethernet, WAN connection, Internet, etc. or via any other networking methodologies that connect different computing systems and allow them to communicate with one another. The various functionalities and modules of the systems and methods of the present disclosure may be implemented or carried out distributedly on different processing systems (e.g., 2, 14, 16), or on any single platform, for instance, accessing data stored locally or distributedly on the network.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method for filtered presentation of structured data at debug time, comprising:
enabling, using a processor, specifying of one or more filters for presentation during a debug procedure;
applying, using a processor, the one or more filters to data structures of a program execution environment;
presenting one or more data values of the data structures meeting one or more criteria specified in the one or more filters.

2. The method of claim 1, wherein the one or more filters identify a data structure type and one or more fields in the data structure type.

3. The method of claim 1, wherein the one or more filters identify a data structure type, one or more fields in the data structure type, and one or more conditions associated with the one or more fields in the data structure type.

4. The method of claim 1, wherein the data values are presented at one or more breakpoints during program debugging.

5. The method of claim 1, wherein the data values are presented during a postmortem inspection of program data.

6. The method of claim 1, wherein the data values are sampled periodically as a program executes and presented to a developer according to the specified one or more filters.

7. A system for filtered presentation of structured data at debug time, comprising:
a processor;
a user interface module operable to enable a user to specify one or more filters for presentation during debug procedure;
a debug module operable to apply the one or more filters to data structures of a program execution environment and identify data values of the data structures meeting one or more criteria specified in the one or more filters.

8. The system of claim 7, wherein the user interface module is further operable to present the data values of the data structures meeting one or more criteria specified in the one or more filters identified by the debug module.

9. The system of claim 7, wherein the one or more filters identify a data structure type and one or more fields in the data structure type.

10. The system of claim 7, wherein the one or more filters identify a data structure type, one or more fields in the data structure type, and one or more conditions associated with the one or more fields in the data structure type.

11. The system of claim 7, wherein the data values are presented at one or more breakpoints during program debugging.

12. The system of claim 7, wherein the data values are presented during a post-mortem inspection of program data.

13. The system of claim 7, wherein the data values are sampled periodically and presented dynamically during program execution.

14. The system of claim 7, wherein the debug module and the user interface module are part of a program development environment tool.

15. A computer readable storage medium storing a program of instructions executable by a machine to perform a method of filtered presentation of structured data at debug time, comprising:
enabling, using a processor, specifying of one or more filters for presentation during a debug procedure;
applying, using a processor, the one or more filters to data structures of a program execution environment;
presenting data values of the data structures meeting one or more criteria specified in the one or more filters.

16. The computer readable storage medium of claim 15, wherein the one or more filters identify a data structure type and one or more fields in the data structure type.

17. The computer readable storage medium of claim 15, wherein the one or more filters identify a data structure type, one or more fields in the data structure type, and one or more conditions associated with the one or more fields in the data structure type.

18. The computer readable storage medium of claim 15, wherein the data values are presented at one or more breakpoints during program debugging.

19. The computer readable storage medium of claim 15, wherein the data values are presented during a postmortem inspection of program data.

20. The computer readable storage medium of claim 15, wherein the data values are sampled periodically and presented dynamically during program execution.
